(19) United States
(12) Patent Application Publication
(10) Pub. No.: US 2005/0171911 A1
(43) Pub. Date: Aug. 4, 2005

(54) Method and system for managing leased electronic equipment

(76) Inventors: Po-Hsing Lee, Taipei Hsien (TW); Chia-Chen Ho, Ping Tung Hsien (TW); Ming-Hsing Hsieh, Kaohsiung City (KR)

Correspondence Address: HARNESS, DICKEY & PIERCE, P.L.C., P.O. BOX 8910, RESTON, VA, 20195, US

(21) Appl. No.: 10/768,045

(22) Filed: Feb. 2, 2004

(51) Int. Cl. H04L 9/00

(52) U.S. Cl. 705/50

(57) ABSTRACT

In a method of managing a leased electronic equipment, during initial activation of the electronic equipment, an encrypted authorization code inputted by a lessee and containing a contract starting date and an equipment disable date that are associated with a lease contract for the electronic equipment between a lessor and the lessee is decrypted according to a decryption algorithm. When a current activation date is within an equipment enable period that starts from the contract starting date and that ends at the equipment disable date, further operation of the electronic equipment is enabled. Otherwise, further operation of the electronic equipment is disabled. A system for managing a leased electronic equipment is also disclosed.

### BACKGROUND OF THE INVENTION

1. Field of the Invention

The invention relates to a method and system for managing leased electronic equipment.

2. Description of the Related Art

When managing leased equipment, the lessee is able to use the leased equipment during a contract period that starts from a contract starting date and ends at a contract expiry date in accordance with a lease contract between the lessee and the lessor. When the lease contract has expired, the lessee can either extend the lease contract or return the leased equipment to the lessor.

As such, it is necessary for the lessor to frequently check whether the lease contract corresponding to the leased equipment has expired, thereby arising in inconvenience.

On the other hand, when the lessee is unable to return the leased equipment after expiration of the lease contract, the lessee is usually required to pay a penalty fee, thereby resulting in higher costs.

### SUMMARY OF THE INVENTION

Therefore, the object of the present invention is to provide a method and system for managing a leased electronic equipment through the use of an encrypted authorization code so as to eliminate the aforesaid drawbacks of the prior art.

According to one aspect of the present invention, there is provided a method of managing a leased electronic equipment. The method comprises the steps of:
(a) during initial activation of the electronic equipment, allowing a lessee to input an encrypted authorization code associated with a lease contract for the electronic equipment between a lessor and the lessee, the authorization code containing a contract starting date and an equipment disable date associated with the lease contract;
(b) decrypting the authorization code inputted by the lessee according to a decryption algorithm;
(c) enabling further operation of the electronic equipment when a current activation date of the electronic equipment is within an equipment enable period that starts from the contract starting date and that ends at the equipment disable date; and
(d) disabling further operation of the electronic equipment when the current activation date is not within the equipment enable period.

According to another aspect of the present invention, there is provided a system for managing a leased electronic equipment. The system comprises:
means for allowing a lessee to input an encrypted authorization code associated with a lease contract for the electronic equipment between a lessor and the lessee during initial activation of the electronic equipment, the authorization code containing a contract starting date and an equipment disable date associated with the lease contract;
means for decrypting the authorization code inputted by the lessee according to a decryption algorithm;
means for enabling further operation of the electronic equipment when a current activation date of the electronic equipment is within an equipment enable period that starts from the contract starting date and that ends at the equipment disable date; and
means for disabling further operation of the electronic equipment when the current activation date is not within the equipment enable period.

According to a further aspect of the present invention, an equipment leasing method comprises the steps of:
providing an electronic equipment for lease; and
generating an encrypted authorization code associated with a lease contract for the electronic equipment between a lessor and a lessee, the authorization code containing a contract starting date and an equipment disable date, wherein the electronic equipment is enabled during an equipment enable period that starts from the contract starting date and that ends at the equipment disable date upon decryption by the electronic equipment of the authorization code inputted by the lessee.

According to yet another aspect of the present invention, there is provided a system for managing an electronic equipment to be leased. The system comprises:
a database unit for storing information pertinent to a lease contract for the electronic equipment between a lessor and a lessee; and
a processor unit coupled electrically to the database unit and generating an encrypted authorization code associated with the lease contract, the authorization code containing a contract starting date and an equipment disable date.

Operation of the electronic equipment is enabled during an equipment enable period that starts from the contract starting date and that ends at the equipment disable date upon decryption by the electronic equipment of the authorization code inputted by the lessee.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating a system configuration used in the preferred embodiment of a method for managing leased electronic equipment according to the present invention;

FIG. 2 is a schematic block diagram illustrating a leased electronic equipment terminal of the preferred embodiment;

FIG. 3 is a flow chart illustrating how the leased electronic equipment is managed in accordance with the method of the preferred embodiment;

FIG. 4 is a schematic block diagram illustrating a system used by a lessor according to the preferred embodiment; and

FIG. 5 is a flow chart illustrating how a lessor manages a leased electronic equipment in accordance with the method of the preferred embodiment.

### DETAILED DESCRIPTION OF THE PREFERRED EMBODIMENT

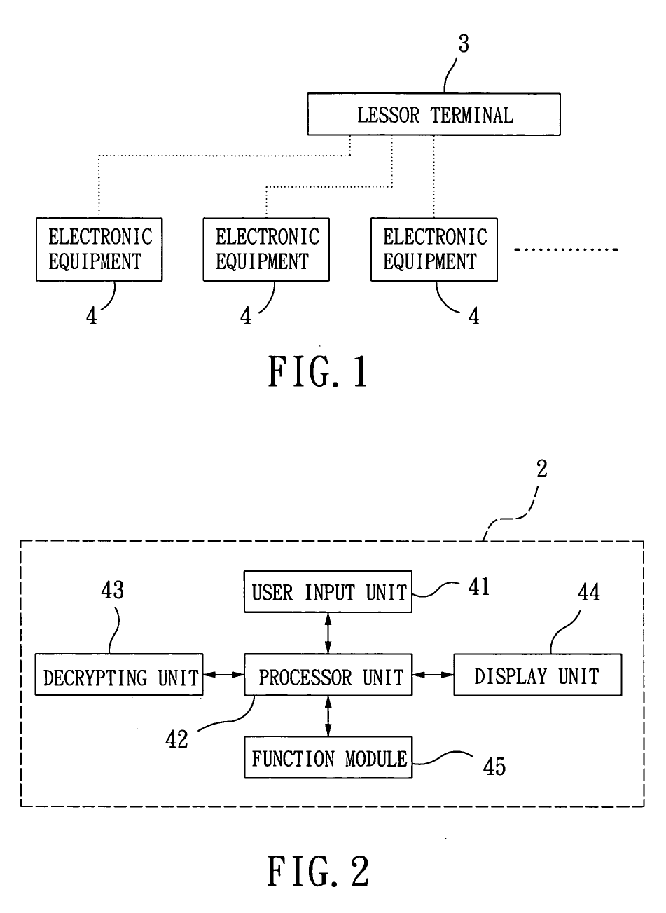

FIG. 1 illustrates a system configuration used in the preferred embodiment of a method of managing leased electronic equipment in accordance with this invention. The system configuration includes a lessor terminal 3, and a plurality of electronic equipments 4 to be managed by the lessor terminal 3.

Referring to FIG. 2, each of the electronic equipments 4 incorporates a managing system 2 that includes a user input unit 41, a decrypting unit 43, a display unit 44, and a processor unit 42 coupled electrically to the user input unit 41, the decrypting unit 43 and the display unit 44. The managing system 2 manages operation of a function module 45 of the electronic equipment 4.

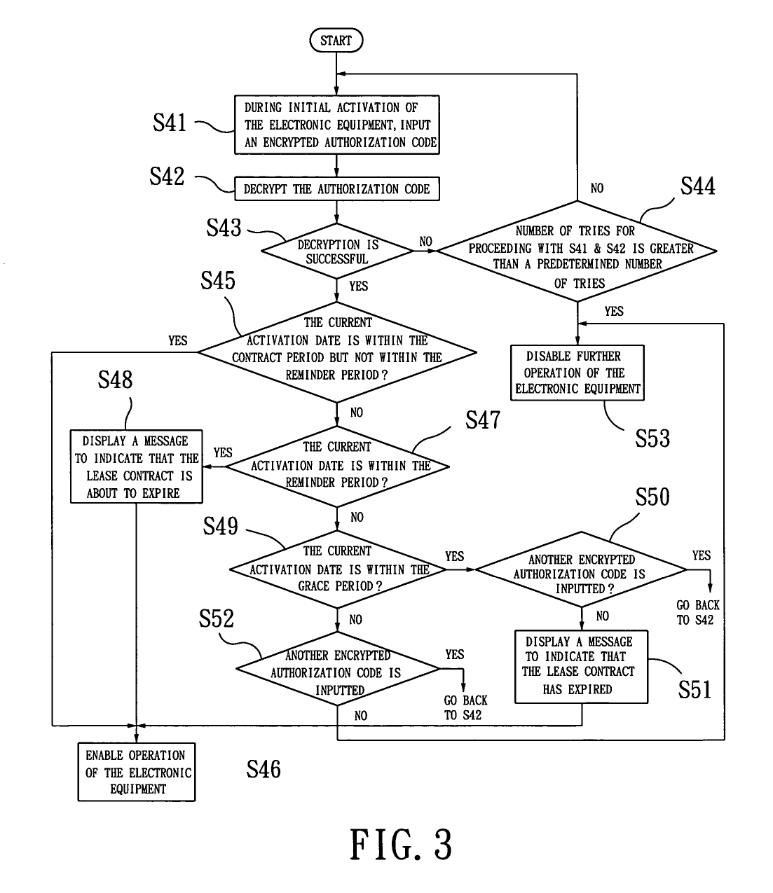

Referring to FIG. 3, there is shown a flow chart to illustrate how the leased electronic equipment 4 is managed in accordance with the method of the preferred embodiment. In Step S41, during initial activation of the electronic equipment 4, the processor unit 42 allows a lessee to input an encrypted authorization code associated with a lease contract for the electronic equipment 4 between a lessor and the lessee via the user input unit 41. The authorization code contains a contract starting date, an equipment disable date associated with the lease contract, and a serial number of the electronic equipment 4. An equipment enable period starts from the contract starting date and ends at the equipment disable date. In this embodiment, the equipment enable period includes a contract period that starts from the contract staring date and that ends at a contract expiry date, and a grace period, such as three days, that starts from the contract expiry date and that ends at the equipment disable date. The contract period includes a reminder period, such as three days, that starts from a reminder date and that ends at the contract expiry date. Instep S42, the processor unit 42 enables the decrypting unit 43 to decrypt the authorization code inputted by the lessee according to a decryption algorithm in a known manner. Instep S43, the processor unit 42 verifies whether decryption of the authorization code is successful. In step S44, when decryption of the authorization code is not successful, the processor unit 42 verifies whether a number of tries for proceeding with steps S41 and S42 is greater than a predetermined number of tries. If no, steps S41 and S42 are repeated. Otherwise, when the number of tries for proceeding with steps S41 and S42 is greater than the predetermined number of tries, such as ten tries, the flow goes to step S53, in which the processor unit 42 disables further operation of the function module 45 of the electronic equipment 4, i.e., the processor unit 42 disables the function module 45 of the electronic equipment 4. In step S45, when decryption of the authorization code is successful, the processor unit 42 verifies whether a current activation date of the electronic equipment 4 is within an equipment enable period but not within the reminder period. In step S46, when the current activation date of the electronic equipment 4 is within the equipment enable period but not within the reminder period, the processor unit 42 enables further operation of the electronic equipment 4, i.e., the processor unit 42 enables the function module 45 of the electronic equipment 4 to permit normal use of the latter. In step S47, the processor unit 42 verifies whether the current activation date is within the reminder period. In step S48, when the current activation date is within the reminder period, the processor unit 42 enables the display unit 44 to display a message to indicate that the lease contract is about to expire, and the flow then goes to step S46. In step S49, upon verifying that the current activation date is not within the reminder period, the processor unit 42 verifies whether the current activation date is within the grace period. In step S50, when the current activation date is within the grace period, the processor unit 42 allows the lessee to input another encrypted authorization code associated with an extension or renewal of the lease contract via the user input unit 41. If another authorization code was inputted, the flow goes back to S42 so as to permit updating of the equipment disable date. In step S51, when the current activation date is within the grace period, and another encrypted authorization code was not inputted by the lessee, the processor unit 42 enables the display unit 44 to display a message to indicate that the lease contract has expired, and the flow then goes to step S46. In step S52, when the current activation date is no longer within the equipment enable period, the processor unit 42 allows the lessee to input another encrypted authorization code associated with an extension or renewal of the lease contract via the user input unit 44. If another authorization code was inputted, the flow goes back to step S42 so as to permit updating of the equipment disable date. When the current activation date is no longer within the equipment enable period, and another authorization code was not inputted by the lessee, the flow goes to step S53.

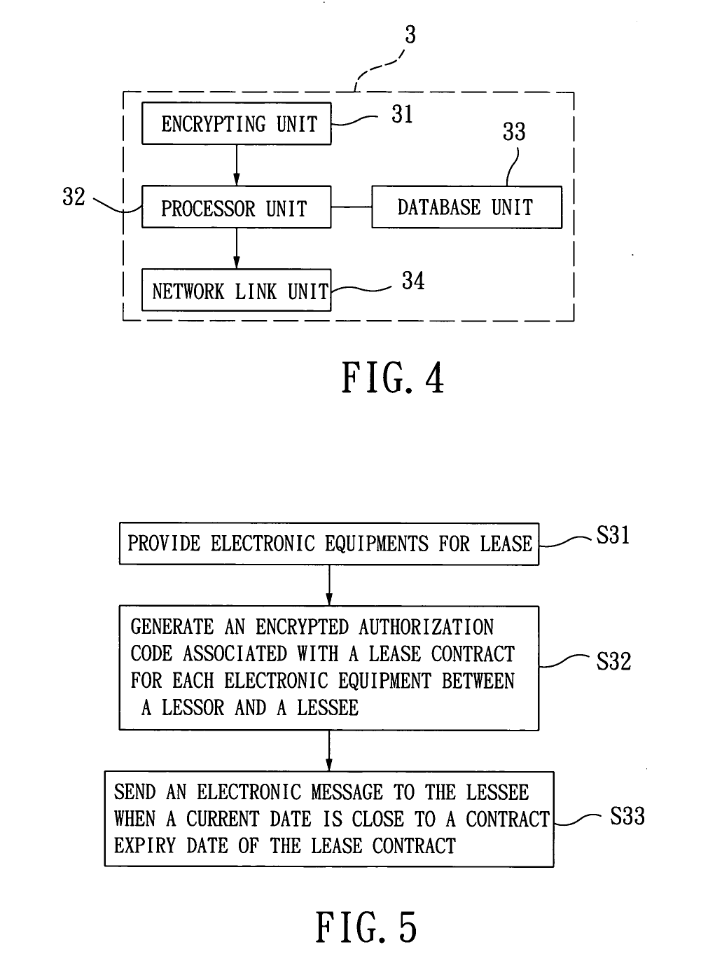

Referring to FIG. 4, a system 3 used by the lessor in the preferred embodiment is shown to include an encrypting unit 31, a database unit 33, a network link unit 34, and a processor unit 32 coupled electrically to the encrypting unit 31, the database unit 33 and the network link unit 34.

The database unit 32 stores information pertinent to a lease contract for each of the leased electronic equipments 4 between the lessor and a corresponding lessee.

Referring to FIG. 5, there is shown a flow chart to illustrate how the lessor manages a plurality of the leased electronic equipments 4 in accordance with the method of the preferred embodiment. In step S31, the lessor provides the electronic equipments 4 for lease. Instep S32, the processor unit 32 enables the encrypting unit 31 to generate an encrypted authorization code associated with the lease contract according to an encryption algorithm corresponding to the decryption algorithm in a known manner. The authorization code contains a contract starting date and an equipment disable date, whereby operation of the electronic equipment 4 is enabled during an equipment enable period that starts from the contract starting date and that ends at the equipment disable date upon decryption by the electronic equipment 4 of the authorization code inputted by the corresponding lessee. In this embodiment, the equipment enable period includes a contract period that starts from the contract starting date and that ends at a contract expiry date. In step S33, the processor unit 32 sends an electronic message, such as an e-mail, a recorded voice message or a fax transmission, to the corresponding lessee via the network link unit 34 when a current date is close to the contract expiry date to indicate that the lease contract is about to expire.

To sum up, due to the use of the encrypted authorization code associated with the lease contract between the lessor and the corresponding lessee in this invention, each leased electronic equipment 4 can be certainly disabled upon verifying that the current activation date is not within the equipment enable period corresponding to the lease contract such that payment of penalty fee is no longer necessary. As the system 3 of the lessor can send reminders automatically when the lease contracts are about to expire, the lessor is able to conveniently manage a large number of the electronic equipments 4. Moreover, the presence of the grace period gives the lessee ample time to renew or extend the lease contract to ensure uninterrupted normal operation of the leased electronic equipment 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of managing a leased electronic equipment, comprising the steps of:
(a) during initial activation of the electronic equipment, allowing a lessee to input an encrypted authorization code associated with a lease contract for the electronic equipment between a lessor and the lessee, the authorization code containing a contract starting date and an equipment disable date associated with the lease contract;
(b) decrypting the authorization code inputted by the lessee according to a decryption algorithm;
(c) enabling further operation of the electronic equipment when a current activation date of the electronic equipment is within an equipment enable period that starts from the contract starting date and that ends at the equipment disable date; and
(d) disabling further operation of the electronic equipment when the current activation date is not within the equipment enable period.

2. The method as claimed in claim 1, further comprising, between steps (b) and (c):
(b-1) when decryption of the authorization code is not successful, repeating steps (a) and (b) until decryption of the authorization code inputted by the lessee is successful.

3. The method as claimed in claim 2, wherein, in step (b-1), further operation of the electronic equipment is disabled when decryption of the authorization code has yet to be successful after a predetermined number of tries.

4. The method as claimed in claim 1, wherein the authorization code further contains a serial number of the electronic equipment.

5. The method as claimed in claim 1, wherein the equipment enable period includes a contract period that starts from the contract starting date and that ends at a contract expiry date, and a grace period that starts from the contract expiry date and that ends at the equipment disable date.

6. The method as claimed in claim 5, wherein the contract period includes a reminder period that starts from a reminder date and that ends at the contract expiry date, and wherein step (c) includes the sub-steps of:
(c-1) when the current activation date is within the contract period but not within the reminder period, enabling further operation of the electronic equipment;
(c-2) when the current activation date is within the reminder period, displaying a message to indicate that the lease contract is about to expire before enabling further operation of the electronic equipment;
(c-3) when the current activation date is within the grace period, allowing the lessee to input another encrypted authorization code for repeating steps (a) and (b) so as to update the equipment disable date; and
(c-4) when the current activation date is within the grace period, upon verifying that said another encrypted authorization code was not inputted, displaying a message to indicate that the lease contract has expired before enabling further operation of the electronic equipment.

7. The method as claimed in claim 1, wherein step (d) includes the sub-steps of:
(d-1) when the current activation date is not within the equipment enable period, allowing the lessee to input another encrypted authorization code for repeating steps (a) and (b) so as to update the equipment disable date; and
(d-2) when the current activation date is not within the equipment enable period, upon verifying that said another encrypted authorization code was not inputted, disabling further operation of the electronic equipment.

8. A system for managing a leased electronic equipment, comprising:
means for allowing a lessee to input an encrypted authorization code associated with a lease contract for the electronic equipment between a lessor and the lessee during initial activation of the electronic equipment, the authorization code containing a contract starting date and an equipment disable date associated with the lease contract;
means for decrypting the authorization code inputted by the lessee according to a decryption algorithm;
means for enabling operation of the electronic equipment when a current activation date of the electronic equipment is within an equipment enable period that starts from the contract starting date and that ends at the equipment disable date; and
means for disabling further operation of the electronic equipment when the current activation date is not within the equipment enable period.

9. An equipment leasing method, comprising the steps of:
providing an electronic equipment for lease; and
generating an encrypted authorization code associated with a lease contract for the electronic equipment between a lessor and a lessee, the authorization code containing a contract starting date and an equipment disable date, wherein the electronic equipment is enabled during an equipment enable period that starts from the contract starting date and that ends at the equipment disable date upon decryption by the electronic equipment of the authorization code inputted by the lessee.

10. The equipment leasing method as claimed in claim 9, wherein the equipment enable period includes a contract period that starts from the contract starting date and that ends at a contract expiry date, said equipment leasing method further comprising the step of:
sending an electronic message to the lessee when a current date is close to the contract expiry date to indicate that the lease contract is about to expire.

11. A system for managing an electronic equipment to be leased, comprising:
a database unit for storing information pertinent to a lease contract for the electronic equipment between a lessor and a lessee; and
a processor unit coupled electrically to said database unit and generating an encrypted authorization code associated with the lease contract, the authorization code containing a contract starting date and an equipment disable date, whereby operation of the electronic equipment is enabled during an equipment enable period that starts from the contract starting date and that ends at the equipment disable date upon decryption by the electronic equipment of the authorization code inputted by the lessee.

12. The system as claimed in claim 11, wherein the equipment enable period includes a contract period that starts from the contract starting date and that ends at a contract expiry date, said system further comprising a network link unit coupled electrically to said processor unit, said processor unit sending an electronic message to the lessee via said network link unit when a current date is close to the contract expiry date to indicate that the lease contract is about to expire.
